(19) United States
(12) Patent Application Publication
(10) Pub. No.: US 2009/0122277 A1
(43) Pub. Date: May 14, 2009

(54) PROJECTION LENS WITH EXTERIOR STOP

(76) Inventors: Estill Thone Hall, Jr., Fishers, IN (US); Jingbo Cai, Vista, CA (US); Eugene Murphy O'Donnell, Fishers, IN (US)

Correspondence Address: FLETCHER YODER P.C., 7915 FM 1960 RD. WEST, SUITE 330, HOUSTON, TX, 77070, US

(21) Appl. No.: 12/300,442

(22) PCT Filed: May 26, 2006
(86) PCT No.: PCT/US06/20852

§ 371 Date: Nov. 11, 2008

(51) Int. Cl. G02B 27/18; G02B 3/00; G03B 21/28

(52) U.S. Cl. 353/97; 359/738; 359/726

(57) ABSTRACT

The disclosed embodiments relate to a system and method for medium wide-angle projection system. An exemplary embodiment of the present technique comprises an imaging system configured to create an image, a lens having a front surface and a back surface, the lens configured to receive an image on the back surface and produce a medium wide-angle representation of the image on the front surface, and an aperture stop positioned adjacent to the front surface of the lens to capture the medium wide-angle representation of the image from the lens.

### CROSS-REFERENCE TO RELATED APPLICATIONS

This application is a National Phase 371 Application of PCT Application No. PCT/US06/20852, filed May 26, 2006, entitled “Projection Lens with Exterior Stop”.

### FIELD OF THE INVENTION

The present invention relates generally to projection lens systems for video display. More specifically, the present invention relates to a system and method for optimally coupling a projection system to a wave-guide structure.

### BACKGROUND OF THE INVENTION

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Projection systems employed in video display units typically utilize lenses adapted to disperse light in a wide cone. The wide cone of light is usually projected on a screen disposed relatively far away form the projection system. As one of ordinary skill in the art would appreciate, such lenses typically have a structure by which chief light rays are made roughly parallel towards the front of the lens of the projection system. This is usually achieved by embedding an exit pupil deep within the lens, adapting the light rays to be parallel and attain a “wide waist.” In order to further widen the light beam, strong negative lens elements are disposed subsequent to the parallel rays, thus increasing their divergence. Further, wide angle projection systems are typically adapted to be disposed somewhat at a distance away from a display device rather than directly adjacent to it. In this manner, it may be possible to achieve a greater wide angle projection.

Although wide-angle projection is common, there are video systems for which the use of a wide-angle projection system may not be an optimal choice. In systems such as wedge displays comprising a screen in the form of a wedge, light exiting the projection lens system may be inserted into a small entrance aperture of the wedge display. The light entering the wedge display may be projected at an angle relative to the wedge display, such that the light undergoes multiple total internal reflections as it propagates through the wedge to form an image. In this manner, an image can be formed on a screen having a relatively small width. Consequently, due to the small entrance pupil and the manner in which the image is projected thereon, the use of a wide-angle projection system may be incompatible with a use of wedge display devices.

Such incompatibility stems from the mismatch between the large beam size produced by a wide-angle projection system and the small entrance pupil of the display device. Further, images projected onto wedge display systems are typically done so at some angle. Utilizing a wide-angle projection system for such a purpose may not be suitable. Such incompatibilities, as those mentioned herein, may cause a general loss of light-coupling efficiency between the display device and the projection system. Ultimately this may degrade the quality of the image displayed on a display device. A system and method that allows the use of medium wide-angle projection in such circumstances is desirable.

### SUMMARY OF THE INVENTION

Certain aspects commensurate in scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

The disclosed embodiments relate to a video unit, comprising an imaging system configured to create an image, a lens having a front surface and a back surface, the lens configured to receive an image on the back surface and produce a medium wide-angle representation of the image on the front surface, and an aperture stop positioned adjacent to the front surface of the lens to capture the medium wide-angle representation of the image from the lens.

### BRIEF DESCRIPTION OF THE DRAWINGS

Advantages of the invention may become apparent upon reading the following detailed description and upon reference to the drawings in which:

FIG. 1 is a block diagram of a video unit in accordance with an exemplary embodiment of the present invention;

FIG. 2 is a diagram of a projection lens system in accordance with an exemplary embodiment of the present invention;

FIG. 3 is a diagram of a projection lens system in accordance with an exemplary embodiment of the present invention; and

FIG. 4 is a flow chart that shows a method in accordance with an exemplary embodiment of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

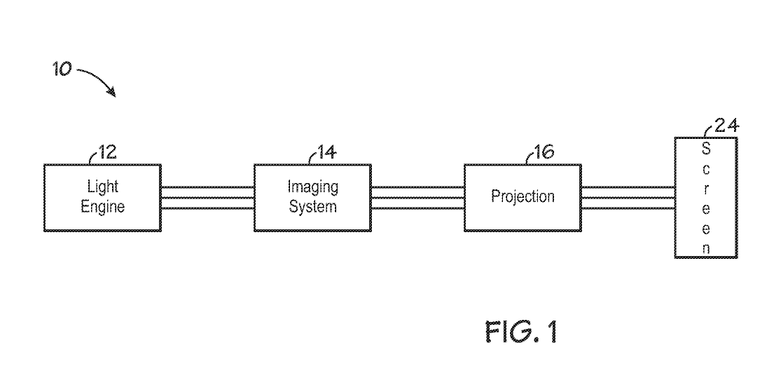

Turning initially to FIG. 1, a block diagram of a video unit in accordance with an exemplary embodiment of the present invention is illustrated and generally designated by a reference numeral 10. The video unit 10 may comprise a Digital Light Processing (“DLP”) projection television or projector. In another embodiment, the video unit 10 may comprise a liquid crystal display (“LCD”) projection television or projector. In still other embodiments, the video unit 10 may comprise another suitable form of projection television or display.

The video unit 10 may include a light engine 12. The light engine 12 is configured to generate white or colored light that can be employed by an imaging system 14 to create a video image. The light engine 12 may include any suitable form of lamp or bulb capable of projecting white or generally white light. In one embodiment, the light engine 12 may be a high intensity light source, such as a metal halide lamp or a mercury vapor lamp. For example, the light engine 12 may include an ultra high performance (“UHP”) lamp produced by Philips Electronics. The light engine 12 may also include a component configured to convert the projected white light into colored light, such as color wheels, dichroic mirrors, polarizers, and filters. Moreover, in alternate embodiments, the light engine 12 may include components capable of generating color light, such as light emitting diodes.

As described above, the light engine 12 may be configured to project, shine, or focus colored light at the imaging system 14. The imaging system 14 may be configured to employ the colored light to create images suitable for display on a screen 24. The imaging system 14 may be configured to generate one or more pixel patterns that can be used to calibrate pixel shifting in the video unit 10. In one embodiment, the imaging system 14 comprises a DLP imaging system that employs one or more DMDs to generate a video image using the colored light. In another embodiment, the imaging system may employ an LCD projection system. It will be appreciated, however, that the above-described exemplary embodiments are not intended to be exclusive, and that in alternate embodiments, any suitable form of imaging system 14 may be employed in the video unit 10.

As illustrated in FIG. 1, the imaging system 14 may be configured to project images into a medium wide-angle projection lens assembly 16, identified as “projection” in FIG. 1. As described further below, the medium wide-angle projection lens assembly 16 may include one or more lenses and/or mirrors that project the image created by the imaging system 14 onto the screen 24. The display screen 24 may comprise a wedge display device configured to receive light from the projection system 16. The light entering the wedge display 24 enters at an angle, such that it undergoes total internal reflection on the side the wedge until a critical angle between the wedge and the light therein is obtained. Once this occurs, a viewable image is formed on a side of the wedge.

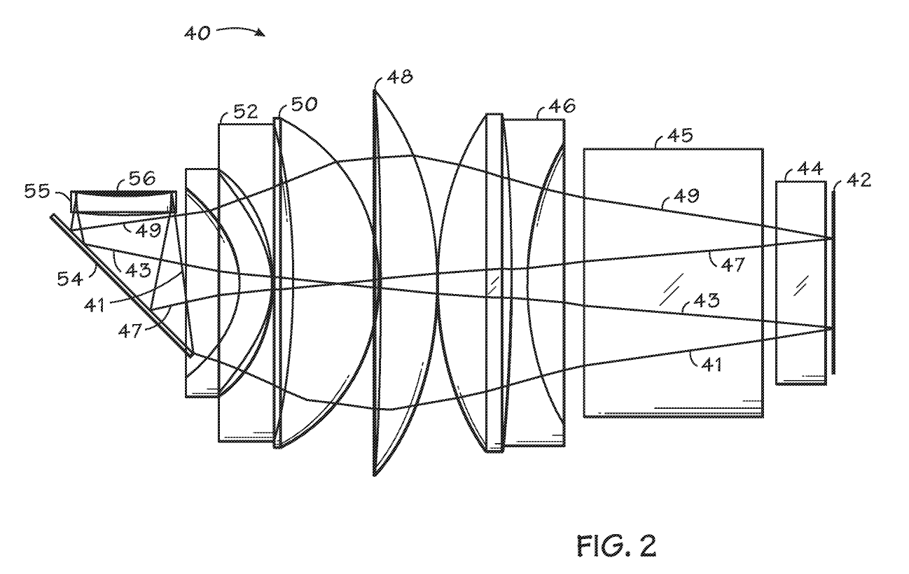

FIG. 2 is a diagram of a projection lens system in accordance with an exemplary embodiment of the present invention, generally designated by reference numeral 40. The system 40 illustrated in FIG. 2 is adapted to produce medium-wide-angle projection of light. Such a projection system adapts light components exiting the projection lens assembly 40 to optimally enter a small entrance pupil, such as the one provided by wedge display 24. Further, by providing medium-wide angle projection of light, the lens assembly 40 allows direct coupling between the projection system 16 and the display system 24 such that the two may be adjacent. Such a configuration increases the light coupling efficiency between the projection system 16 and the display system 24.

Accordingly, FIG. 2 depicts imaging device 42, such as a DMD, and its cover glass 44 disposed at one end of the assembly 40. The DMD 42 generates light components that are further processed for medium-wide-angle projection via lens elements comprising the system 40. In this exemplary embodiment, the DMD 42 provides a plane from which exemplary chief light rays 41, 43, 47, and 49 originate in the lens assembly 40. Although only four exemplary light rays are shown in FIG. 2, it should be appreciated by those skilled in the art that, in actuality, a bundle of light rays emanates from the DMD 42.

The system 40 further includes a total internal reflection (TIR) prism 45, disposed adjacent to the cover glass 44. Colored light components comprising red, green, and blue (RGB) are emitted by the DMD 42 and projected through the TIR prism 45. In addition to the colored light components, image illumination light components (not shown) are also entering the TIR prism 45 enroute to the DMD 42 as well. The purpose of the TIR prism 45 is to direct these two different light bundles to their respective destinations. That is, the illumination light is directed to the DMD 42 and the colored light components are directed into first lens element 46. Accordingly, the TIR prism 45 is adapted to separate the image into RGB and illumination components.

The light rays exiting the TIR prism 45 are next projected onto a double negative lens 46. The lens 46 is adapted to increase the rate of spread and, thus, diverge chief light rays 41, 43, 47 and 49, as those emerge from the TIR prism 45. In this manner, the lens 46 initially formats light rays projected thereon before those are subsequently processed by additional lens elements of the system 40. Accordingly, the light rays 41, 43, 47 and 49, maximally divergent at this point, are next projected onto a large positive lens 48. The lens 48 comprises a large diameter and is adjacent to the lens 46, such that the two may be in physical contact. The lens 48 is further configured to initially converge the chief light rays 41, 43, 47 and 49, as these rays exit the double negative lens 46. Disposing the double negative lens 46 next to the large positive lens 48 allows spreading and, thereafter, converging the light relatively far forward in the lens system 40. This enables the light rays emerging from the lens assembly 40 to be parallel as they enter the display system 24 and, consequently, couple more efficiently therewith.

After emerging from the large positive lens 48, chief light rays 41, 43, 47 and 49 are next projected onto a positive doublet lens 50. The doublet lens 50 is disposed adjacent to the lens 48 and may be in physical contact thereto. The positive doublet lens 50 is utilized for color correcting the light exiting the large positive lens 48. Color correction is needed, as the RGB light components exiting the DMD 42 comprise various electromagnetic wavelengths. Accordingly, each wavelength of the light refracts at a different angle, as the light propagates through the lenses 46 and 48. Hence, the doublet lens 48 helps to ensure that images formed by the different colored-light components are focused appropriately. In focusing the light, the doublet lens 50 further converges the light as it reaches closer to the front of the lens.

Thereafter, the chief light rays 41, 43, 47 and 49 are projected onto an aspherical lens 52 disposed adjacent to the doublet lens 50, such that the two may be in physical contact with one another. The lens 52 is adapted to further converge the light rays emerging from the doublet 50 and, thus, “squeeze” the bundle of rays comprising the projected image. Once emerging from the aspherical lens 52, the chief light rays 41, 43, 47, and 49 are further made parallel to one another as they impinge on a plane mirror 54.

The plane mirror 54 is disposed adjacent to the lens 52. The mirror 54 is used to fold the light, so as to make the lens assembly 40 more compact. Accordingly, the mirror 54 is disposed at a forty five-degree angle relative to the horizontal and vertical components of the lens assembly 40. In this configuration, the mirror 54 reflects the image, causing it to propagate in a vertical direction. Absent the mirror 54, light rays emerging from the lens 52 would continue to propagate along a horizontal path, extending the length of the projection lens system 40. As further depicted in FIG. 2, the bottom portion of mirror 54 protrudes into the lens 52. Such a protrusion is optically desirable, as light rays emerging from the lens 52 are completely received by the mirror 54. This optimizes the coupling efficiency of the mirror 54 to the lens 52. The mirror 54 is further adapted to wiggle synchronously with micro-mirrors comprising the imaging device, such as the one employed in the DMD 42. The synchronous wiggling between the mirror 54 and the micro-mirrors of the display device optimizes the projection of an image generated by the DMD 42 onto an aperture stop 56.

Light reflected from mirror 54 is projected onto a focusing lens 55 disposed between the mirror 54 and the aperture stop 56. The light projected onto lens 55 is focused to from an image, which is in turn projected onto the aperture stop 56. As appreciated by those skilled in the art, an aperture stop determines an exit pupil of a lens. As illustrated by FIG. 2, the exemplary embodiment of the present technique places the exit pupil of the light at the extreme front the lens system 40. By doing so, a “smallest waist” of the ray bundle will occur at the entrance pupil of the display screen 24 (FIG. 1). Hence, providing the “smallest waist” of the ray bundle to the display device 24, optimizes the light coupling efficiency between the projection system 16 (FIG. 1) and the display device 24. Placement of the aperture stop 56 at the extreme front of the lens 40 may further enable to dispose a display device, such as a wedge, adjacent with the lens system 40, such that the two may be in physical contact with one another. This further improves the coupling between the projection system 16 and the display device 24 (FIG. 1).

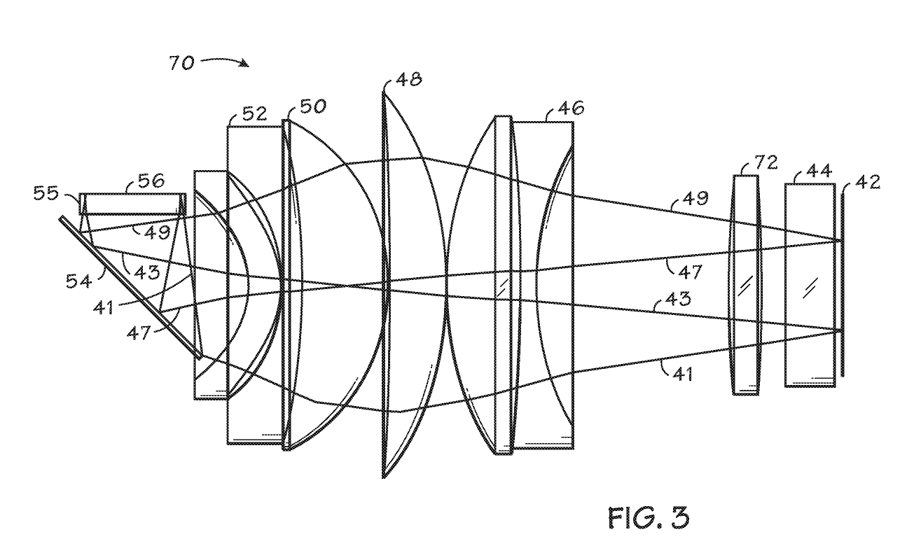

FIG. 3 is a diagram of a projection lens system in accordance with an exemplary embodiment of the present invention, generally designated by reference numeral 70. The system 70 is similar both in structure and in composition to the lens system 40 shown in FIG. 1. However, the system 70 comprises a field lens 72 rather than a TIR prism 45 shown in FIG. 2. The field lens 72 effectively functions like the TIR prism 45, while providing better illumination for the projected image. By employing the field lens 72, the system 70 is more efficient in producing a brighter image on the display device 24.

Lens elements subsequent to the field lens 72 shown in FIG. 3 function in a similar manner to the lens elements adjacent to the TIR prism 45 of system 40 shown in FIG. 2. In both systems, i.e., 40 and 70, the aperture stop 56 is placed at the extreme end of the lens, providing a “smallest waist” of the ray bundle to occur at the entrance pupil of the display screen 24. Further, both the systems 40 and 70 comprise lens elements 46, 48, 50 and 52, all of which are disposed adjacent with prior and subsequent lens elements disclosed herewith. By maintaining a physical contact between the afore-mentioned lens elements, a proper optical alignment between these elements may be easily achieved. This may also ease manufacturing of lens systems, such as those described herewith, as keeping a proper repeatable gap between the above mentioned lens elements during manufacturing is more conveniently facilitated when those elements are placed in physical contact with one another.

Spot diagrams of a projection system may be utilized to analyze performance of a projection system. Accordingly, data collected from such diagrams comprises pixel fields, whereby each field represents an image of a pixel on a display device. Further, each field represents a pixel having a unique root mean square (RMS) and geometrical (GEO) radius spot size for a certain box width, as may be appreciated by those of ordinary skill in the art. Accordingly, the performance of lens system 40 is analyzed via seven fields, each having a unique RMS and GEO radius for a box width of 12 micrometers. The fields represent an image of a pixel disposed on the DMD 42. The data of exemplary spot diagrams of system 40 is summarized in Table 1 below, where all units are in micrometers:

TABLE 1

| Field | 1 | 2 | 3 | 4 | 5 | 6 | 7 |
|---|---|---|---|---|---|---|---|
| RMS | 2.785 | 3.338 | 3.344 | 5.727 | 6.035 | 9.591 | 9.591 |
| Radius | | | | | | | |
| Geo | 4.580 | 9.236 | 9.407 | 12.076 | 13.780 | 49.368 | 49.368 |
| Radius | | | | | | | |

Similarly, the performance of lens system 70 is analyzed via seven fields, each having a unique RMS and geometrical (GEO) radius for a box width of 12 micrometers. The fields represent an image of a pixel disposed on the DMD 42. The data of the spot diagrams of system 70 is summarized in Table 2 below, where all units are in micrometers:

TABLE 2

| Field | 1 | 2 | 3 | 4 | 5 | 6 | 7 |
|---|---|---|---|---|---|---|---|
| RMS | 1.491 | 4.268 | 4.364 | 4.554 | 4.782 | 7.570 | 7.570 |
| Radius | | | | | | | |
| Geo | 2.662 | 11.670 | 12.139 | 9.258 | 11.374 | 23.393 | 23.393 |
| Radius | | | | | | | |

Further, the systems 40 and 70 have a modulation transfer function (MTF), which yields a value of 50%, considered as a worst case when evaluated at a spatial frequency of 45 lines per millimeter.

Furthermore, an exemplary embodiment of the system 40 produces a grid distortion of 0.3415%, while an exemplary embodiment of the system 70 produces a grid distortion of 0.2306%. In addition, the system 40 produces a 19% center to corner light fall-off across a screen. Similarly, the system 70 produces a 20% center to corner light fall-off across a screen. Accordingly, display units employing projection lens system, such as exemplary embodiments of the systems 40 and 70, may considerably out-perform display units employing cathode ray tubes (CRTs). CRT systems typically possess a 70% center to corner light fall-off across a screen, as may be appreciated to those of ordinary skill in the art.

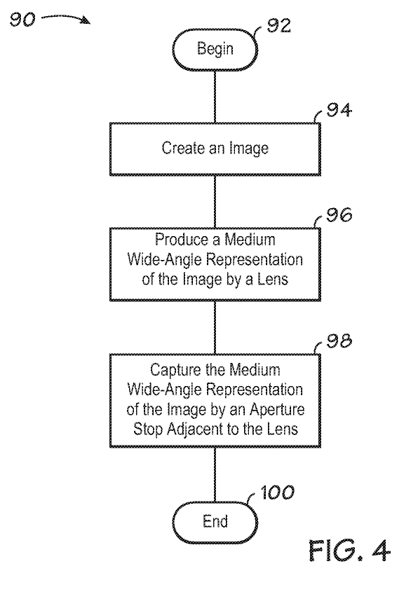

Turning now to FIG. 4, a flow chart in accordance with an exemplary embodiment of the present invention is depicted, and is generally designated by the reference numeral 90. The flow chart 90 describes a method for capturing a medium-wide-angle representation of an image by an aperture stop adjacent to a lens. Such a method may be employed via the lens assemblies 40 and 70 respectively shown by FIGS. 2 and 3. The method begins a block 92. At block 94, an image is created by an imaging device, such as imaging system 14 shown in FIG. 1. Thereafter, at block 96 the projection system 16, via lenses 40 or 70, produces a medium-wide-angle representation of the image. At block 98, a medium-wide-angle representation of the image may be captured by placing an aperture stop adjacent to the lenses 40 or 70. The method ends at block 100.

An example of computer code useful for designing an exemplary embodiment of the present invention is given below:

GENERAL LENS DATA:

| | |
|---|---|
| Surfaces | 19 |
| Stop | 1 |
| System Aperture | Float By Stop Size = 2.93234 |
| Glass Catalogs | SCHOTT SUMITA MISC CORNING |
| Ray Aiming | Off |
| Apodization | Uniform, factor = 0.00000E+000 |
| Effective Focal Length | 15.54322 (in air at system temperature and pressure) |
| Effective Focal Length | 15.54322 (in image space) |
| Back Focal Length | 0.2361997 |
| Total Track | 49.32125 |
| Image Space F/# | 2.65031 |
| Paraxial Working F/# | 2.642447 |
| Working F/# | 2.648663 |
| Image Space NA | 0.1859196 |
| Object Space NA | 0.001865353 |
| Stop Radius | 2.93234 |
| Paraxial Image Height | 5.638907 |
| Paraxial Magnification | −0.009858207 |
| Entrance Pupil Diameter | 5.864679 |
| Entrance Pupil Position | 0 |
| Exit Pupil Diameter | 19.48724 |
| Exit Pupil Position | 51.40041 |
| Field Type | Object height in Millimeters |
| Maximum Radial Field | 572.0013 |
| Primary Wavelength | 0.5875618 μm |
| Lens Units | Millimeters |
| Angular Magnification | −0.3009498 |

Fields: 7
Field Type: Object height in Millimeters

| # | X-Value | Y-Value | Weight |
|---|---|---|---|
| 1 | 0.000000 | 0.000000 | 1.000000 |
| 2 | 0.000000 | 280.425600 | 1.000000 |
| 3 | 249.272400 | 140.212800 | 1.000000 |
| 4 | −423.763080 | −238.361760 | 1.000000 |
| 5 | 498.544800 | 0.000000 | 1.000000 |
| 6 | 498.544800 | 280.425600 | 1.000000 |
| 7 | −498.544800 | −280.425600 | 1.000000 |

Vignetting Factors

| # | VDX | VDY | VCX | VCY | VAN |
|---|---|---|---|---|---|
| 1 | 0.000000 | 0.000000 | 0.000000 | 0.000000 | 0.000000 |
| 2 | 0.000000 | 0.000000 | 0.000000 | 0.000000 | 0.000000 |
| 3 | 0.000000 | 0.000000 | 0.000000 | 0.000000 | 0.000000 |
| 4 | 0.000000 | 0.000000 | 0.000000 | 0.000000 | 0.000000 |
| 5 | 0.000000 | 0.000000 | 0.000000 | 0.000000 | 0.000000 |
| 6 | 0.000000 | 0.000000 | 0.000000 | 0.000000 | 0.000000 |
| 7 | 0.000000 | 0.000000 | 0.000000 | 0.000000 | 0.000000 |

Wavelengths: 3
Units: μm

| # | Value | Weight |
|---|---|---|
| 1 | 0.486133 | 1.000000 |
| 2 | 0.587562 | 1.000000 |
| 3 | 0.656273 | 1.000000 |

SURFACE DATA SUMMARY:

| Surf | Type | Comment | Radius | Thickness | Glass | Diameter | Conic |
|---|---|---|---|---|---|---|---|
| OBJ | STANDARD | | Infinity | 1572 | | 1144.003 | 0 |
| STO | STANDARD | | Infinity | 0.1286122 | | 5.864679 | 0 |
| 2 | STANDARD | | −33.357 | 1.406572 | E05-25 | 5.865072 | 0 |
| 3 | STANDARD | | −23.15633 | 11.21758 | | 6.485073 | 0 |
| 4 | EVENASPH | | −6.343349 | 1.982078 | ACRYLIC | 11.63456 | −0.07049834 |
| 5 | EVENASPH | | −6.673121 | 0.07 | | 13.96911 | −0.5469441 |
| 6 | STANDARD | | −9.199547 | 1.327357 | SF6 | 14.09899 | 0 |
| 7 | STANDARD | | −38.84313 | 5.324974 | LASFN30 | 19.51416 | 0 |
| 8 | STANDARD | | −11.44616 | 0 | | 20.25266 | 0 |
| 9 | STANDARD | | −171.9387 | 3.55259 | N-LAK33A | 23.686 | 0 |
| 10 | STANDARD | | −20.05591 | 0 | | 23.71741 | 0 |
| 11 | STANDARD | | 19.53818 | 4.477497 | N-LASF44 | 20.8171 | 0 |
| 12 | STANDARD | | −86.89034 | 0 | | 20.13523 | 0 |
| 13 | STANDARD | | −88.05859 | 0.9999907 | SF6 | 20.11372 | 0 |
| 14 | STANDARD | | 17.53928 | 3.5 | | 17.16676 | 0 |
| 15 | STANDARD | | Infinity | 11 | BK7 | 16.5196 | 0 |
| 16 | STANDARD | | Infinity | 0.851 | | 12.8455 | 0 |
| 17 | STANDARD | | Infinity | 3 | A87-70 | 12.40709 | 0 |
| 18 | STANDARD | | Infinity | 0.483 | | 11.38602 | 0 |
| IMA | STANDARD | | Infinity | | | 11.24887 | 0 |

SURFACE DATA DETAIL:

| | |
|---|---|
| Surface OBJ | STANDARD |
| Surface STO | STANDARD |
| Surface 2 | STANDARD |
| Surface 3 | STANDARD |
| Surface 4 | EVENASPH |
| Coeff on r 2 | 0 |
| Coeff on r 4 | −0.00031867578 |
| Coeff on r 6 | 4.5897875e−006 |
| Coeff on r 8 | 4.1939748e−007 |
| Coeff on r 10 | −1.3335883e−009 |
| Coeff on r 12 | 0 |
| Coeff on r 14 | 0 |
| Coeff on r 16 | 0 |
| Surface 5 | EVENASPH |
| Coeff on r 2 | 0 |
| Coeff on r 4 | 7.0579508e−007 |
| Coeff on r 6 | −3.7422925e−006 |
| Coeff on r 8 | 4.686479e−007 |
| Coeff on r 10 | −4.6296627e−009 |
| Coeff on r 12 | 0 |
| Coeff on r 14 | 0 |
| Coeff on r 16 | 0 |
| Surface 6 | STANDARD |
| Surface 7 | STANDARD |
| Surface 8 | STANDARD |
| Surface 9 | STANDARD |
| Surface 10 | STANDARD |
| Surface 11 | STANDARD |
| Surface 12 | STANDARD |
| Surface 13 | STANDARD |
| Surface 14 | STANDARD |
| Surface 15 | STANDARD |
| Surface 16 | STANDARD |
| Surface 17 | STANDARD |
| Surface 18 | STANDARD |
| Surface IMA | STANDARD |

A further example of computer code useful for designing an exemplary embodiment of the present invention is given below:

GENERAL LENS DATA:

| | |
|---|---|
| Surfaces | 19 |
| Stop | 1 |
| System Aperture | Float By Stop Size = 2.93234 |
| Glass Catalogs | SCHOTT SUMITA MISC CORNING |
| Ray Aiming | Off |
| Apodization | Uniform, factor = 0.00000E+000 |
| Effective Focal Length | 15.54199 (in air at system temperature and pressure) |
| Effective Focal Length | 15.54199 (in image space) |
| Back Focal Length | 0.2812916 |
| Total Track | 46.25401 |
| Image Space F/# | 2.650101 |
| Paraxial Working F/# | 2.641341 |
| Working F/# | 2.648447 |
| Image Space NA | 0.1859946 |
| Object Space NA | 0.001865353 |
| Stop Radius | 2.93234 |
| Paraxial Image Height | 5.636549 |
| Paraxial Magnification | −0.009854084 |
| Entrance Pupil Diameter | 5.864679 |
| Entrance Pupil Position | 0 |
| Exit Pupil Diameter | 17.484 |
| Exit Pupil Position | 46.13265 |
| Field Type | Object height in Millimeters |
| Maximum Radial Field | 572.0013 |
| Primary Wavelength | 0.5875618 μm |
| Lens Units | Millimeters |
| Angular Magnification | −0.3354312 |

Fields: 7
Field Type: Object height in Millimeters

| # | X-Value | Y-Value | Weight |
|---|---|---|---|
| 1 | 0.000000 | 0.000000 | 1.000000 |
| 2 | 0.000000 | 280.425600 | 1.000000 |
| 3 | 249.272400 | 140.212800 | 1.000000 |
| 4 | −423.763080 | −238.361760 | 1.000000 |
| 5 | 498.544800 | 0.000000 | 1.000000 |
| 6 | 498.544800 | 280.425600 | 1.000000 |
| 7 | −498.544800 | −280.425600 | 1.000000 |

Vignetting Factors

| # | VDX | VDY | VCX | VCY | VAN |
|---|---|---|---|---|---|
| 1 | 0.000000 | 0.000000 | 0.000000 | 0.000000 | 0.000000 |
| 2 | 0.000000 | 0.000000 | 0.000000 | 0.000000 | 0.000000 |
| 3 | 0.000000 | 0.000000 | 0.000000 | 0.000000 | 0.000000 |
| 4 | 0.000000 | 0.000000 | 0.000000 | 0.000000 | 0.000000 |
| 5 | 0.000000 | 0.000000 | 0.000000 | 0.000000 | 0.000000 |
| 6 | 0.000000 | 0.000000 | 0.000000 | 0.000000 | 0.000000 |
| 7 | 0.000000 | 0.000000 | 0.000000 | 0.000000 | 0.000000 |

Wavelengths: 3
Units: μm

| # | Value | Weight |
|---|---|---|
| 1 | 0.486133 | 1.000000 |
| 2 | 0.587562 | 1.000000 |
| 3 | 0.656273 | 1.000000 |

SURFACE DATA SUMMARY:

| Surf | Type | Comment | Radius | Thickness | Glass | Diameter | Conic |
|---|---|---|---|---|---|---|---|
| OBJ | STANDARD | | Infinity | 1572 | | 1144.003 | 0 |
| STO | STANDARD | | Infinity | 0.2225626 | | 5.864679 | 0 |
| 2 | STANDARD | | −19.41004 | 1.406572 | LASFN10 | 5.864844 | 0 |
| 3 | STANDARD | | −16.96976 | 11.25639 | | 6.563957 | 0 |
| 4 | EVENASPH | | −7.09067 | 1.982078 | ACRYLIC | 11.9094 | 0.1113617 |
| 5 | EVENASPH | | −7.769529 | 0.07 | | 14.6702 | −0.5894477 |
| 6 | STANDARD | | −10.15971 | 1.327357 | SF10 | 14.74223 | 0 |
| 7 | STANDARD | | −54.12037 | 5.324974 | LASFN6 | 20.38093 | 0 |
| 8 | STANDARD | | −11.47407 | 0 | | 20.43785 | 0 |
| 9 | STANDARD | | 161.9396 | 3.55259 | C20-60 | 23.24924 | 0 |
| 10 | STANDARD | | −23.20495 | 0 | | 23.2517 | 0 |
| 11 | STANDARD | | 16.41157 | 4.477497 | LASFN30 | 20.41569 | 0 |
| 12 | STANDARD | | −56.70195 | 0 | | 20.10725 | 0 |
| 13 | STANDARD | | −56.73476 | 0.9999907 | SF13 | 20.06745 | 0 |
| 14 | STANDARD | | 10.95483 | 9.6 | | 15.36056 | 0 |
| 15 | STANDARD | | 89 | 1.7 | KZFSN5 | 13.18421 | 0 |
| 16 | STANDARD | | −130 | 0.851 | | 12.86312 | 0 |
| 17 | STANDARD | | Infinity | 3 | A87-70 | 12.38386 | 0 |
| 18 | STANDARD | | Infinity | 0.483 | | 11.45127 | 0 |
| IMA | STANDARD | | Infinity | | | 11.2403 | 0 |

SURFACE DATA DETAIL:

| | |
|---|---|
| Surface OBJ | STANDARD |
| Surface STO | STANDARD |
| Surface 2 | STANDARD |
| Surface 3 | STANDARD |
| Surface 4 | EVENASPH |
| Coeff on r 2 | 0 |
| Coeff on r 4 | −0.00025286684 |
| Coeff on r 6 | 7.56255e−007 |
| Coeff on r 8 | 1.7869307e−007 |
| Coeff on r 10 | 6.7855092e−010 |
| Coeff on r 12 | 0 |
| Coeff on r 14 | 0 |
| Coeff on r 16 | 0 |
| Surface 5 | EVENASPH |
| Coeff on r 2 | 0 |
| Coeff on r 4 | 8.5480533e−007 |
| Coeff on r 6 | −2.2333423e−006 |
| Coeff on r 8 | 2.429173e−007 |
| Coeff on r 10 | −2.1939863e−009 |
| Coeff on r 12 | 0 |
| Coeff on r 14 | 0 |
| Coeff on r 16 | 0 |
| Surface 6 | STANDARD |
| Surface 7 | STANDARD |
| Surface 8 | STANDARD |
| Surface 9 | STANDARD |
| Surface 10 | STANDARD |
| Surface 11 | STANDARD |
| Surface 12 | STANDARD |
| Surface 13 | STANDARD |
| Surface 14 | STANDARD |
| Surface 15 | STANDARD |
| Surface 16 | STANDARD |
| Surface 17 | STANDARD |
| Surface 18 | STANDARD |
| Surface IMA | STANDARD |

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A video unit, comprising:
an imaging system configured to create an image;
a lens having a front surface and a back surface, the lens configured to receive an image on the back surface and produce a medium wide-angle representation of the image on the front surface; and
an aperture stop positioned adjacent to the front surface of the lens to capture the medium wide-angle representation of the image from the lens.

2. The video unit recited in claim 1, comprising a mirror configured to reflect the image to the aperture stop.

3. The video unit recited in claim 2, wherein the mirror is configured to wiggle in accordance with a digital micro device of the imaging system.

4. The video unit recited in claim 2, wherein the mirror protrudes into a portion of the lens.

5. The video unit recited in claim 1, wherein the lens comprises a total internal reflection (TIR) prism.

6. The video unit recited in claim 1, wherein the lens comprises a field lens.

7. The video unit recited in claim 1, wherein the video unit comprises a wedge display configured to display the image.

8. The video unit recited in claim 1, wherein the video unit comprises a digital light processing (DLP) projection system.

9. The video unit recited in claim 1, comprising optical components in physical contact with one another.

10. A method, comprising;
creating an image;
producing a medium wide-angle representation of the image by a lens; and
capturing the medium wide-angle representation of the image by an aperture stop adjacent to the lens.

11. The method recited in claim 10, comprising reflecting the image to the aperture stop.

12. The method recited in claim 10, comprising configuring the mirror to wiggle in accordance with a digital micro device of the imaging system.

13. The method recited in claim 10, wherein the aperture stop is at an extreme end of the lens.

14. The method recited in claim 10, wherein the medium wide-angle representation is captured via a wedge display.

15. The method recited in claim 10, comprising increasing brightness of the image via a field lens.

16. A system, comprising;
a light engine;
an imaging system;
a display system; and
an projection system, comprising:
a lens having a front surface and a back surface, the lens configured to receive an image on the back surface and produce a medium wide-angle representation of the image on the front surface; and
an aperture stop positioned adjacent to the front surface of the lens to capture the medium wide-angle representation of the image from the lens.

17. The system recited in claim 16, wherein the aperture stop is disposed between the lens and the display system.

18. The system recited in claim 16, wherein the display system is disposed substantially adjacent to the projection system.

19. The system recited in claim 16, comprising a mirror that reflects the image to the aperture stop.

20. The system recited in claim 16, comprising a wedge display configured to capture the medium wide-angle representation of the image.
